(19) United States
(12) Patent Application Publication
(10) Pub. No.: US 2018/0110360 A1
(43) Pub. Date: Apr. 26, 2018

(54) BEVERAGE MAKER APPARATUS

(71) Applicant: Eafen Chowdhury, Cherry Hill, NJ (US)

(72) Inventor: Eafen Chowdhury, Cherry Hill, NJ (US)

(21) Appl. No.: 15/298,582

(22) Filed: Oct. 20, 2016

(51) Int. Cl. A47J 31/40; A23L 2/38

(52) U.S. Cl. CPC A47J 31/407; A23V 2002/00; A23L 2/38

(57) ABSTRACT

A beverage maker apparatus for storing refrigerated ingredients and making a beverage includes a refrigerated storage, a control unit, and a container. The refrigerated storage compartment stores the ingredients. The refrigerated storage compartment includes pods for storing the ingredients separately. The ingredients are refrigerated at a set temperature. The control unit displays options to a user and receives a selection of an option from the user. The control unit maintains the pods at the set temperature via feedback from sensors. The control unit actuates one or more of the pods to release one or more of the ingredients based on the selection of the user. The container is positioned on a tray of the beverage maker apparatus for receiving the ingredients from the pods. The container includes rotary blades for processing the ingredients to make the beverage.

### TECHNICAL FIELD OF THE INVENTION

The invention disclosed herein generally relates to beverage making systems. More particularly, the invention relates to a beverage maker apparatus for storing refrigerated ingredients and making a beverage based on user's preference.

### BACKGROUND

Beverages are liquids intended for human consumption. Beverages serve a variety of purposes ranging from satisfying thirst to providing a treat to the taste buds of a consumer. Accordingly, a large variety of beverages have been created by mixing different ingredients, for example, smoothies, health drinks, recreational drinks, etc. Traditionally, beverages such as smoothies are available only in restaurants or specialized beverage facilities. These restaurants or specialized beverage facilities may have a fixed menu of available beverages based on popular user preferences. Although some restaurants provide an option for customizing a beverage, the available options may be minimal. An apparatus, which allows a user to experiment or create a beverage of their choice, is required. Moreover, existing beverages available in the market are expensive, which prevent consumers from buying them. An apparatus, which allows consumers to create beverages of their choice at home economically, is required. Additionally, the ingredients used in most beverages are, for example, fruits, vegetables, milk, etc. These ingredients are perishable in nature. In addition, if the ingredients are organic and produced without the addition of any preservatives, the ingredients are prone to spoil. An apparatus, which preserves the ingredients by refrigerating the ingredients, is required.

Hence, there is a long felt but unresolved need for an apparatus, which allows a user to experiment or create a beverage of their choice. Moreover, there is a need for an apparatus, which allows consumers to create beverages of their choice at home economically. Furthermore, there is a need for an apparatus, which preserves the ingredients by refrigerating the ingredients.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The beverage maker apparatus disclosed herein addresses the above-mentioned need for an apparatus, which allows a user to experiment or create a beverage of their choice. Moreover, the invention addresses the need for an apparatus, which allows consumers to create beverages of their choice at home economically. Furthermore, the invention addresses the need for an apparatus, which preserves the ingredients by refrigerating the ingredients. The beverage maker apparatus for storing refrigerated ingredients and making a beverage comprises a refrigerated storage, a control unit, and a container. The refrigerated storage compartment for storing the ingredients comprises a plurality of pods for storing the ingredients separately. The ingredients are refrigerated at a set temperature. The control unit displays options to a user and is configured to receive a selection of an option from the user. The control unit maintains the pods at the set temperature via feedback from sensors. The control unit actuates one or more of the pods to release one or more of the ingredients based on the selection of the user. The container is positioned on a tray of the beverage maker apparatus for receiving the ingredients from the pods. The container comprises rotary blades for processing the ingredients to make the beverage.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a perspective view of a beverage maker apparatus.

FIG. 2 exemplarily illustrates a right side elevation view of a beverage maker apparatus.

FIG. 3 exemplarily illustrates a schematic diagram of a beverage maker apparatus.

FIG. 4 exemplarily illustrates a method for method for storing refrigerated ingredients and making a beverage.

### DETAILED DESCRIPTION OF THE INVENTION

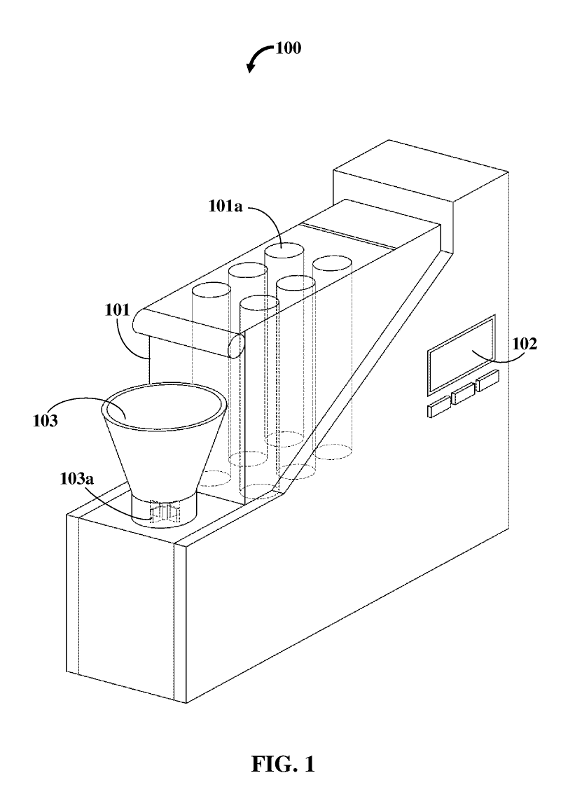

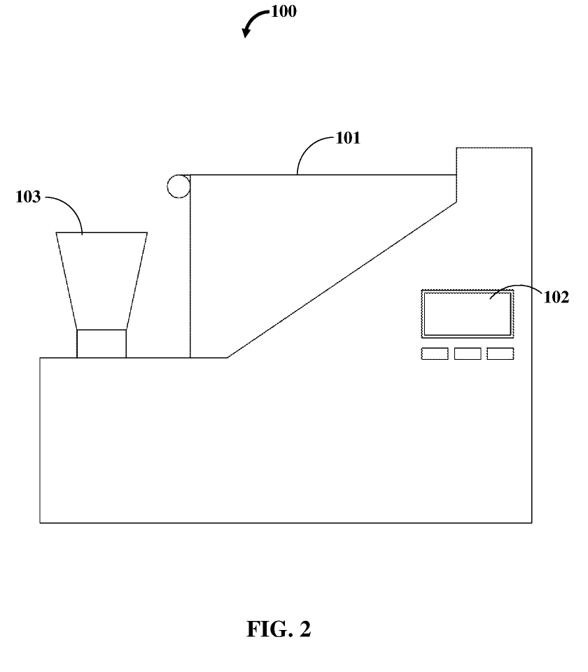

FIG. 1 exemplarily illustrates a perspective view of a beverage maker apparatus 100. FIG. 2 exemplarily illustrates a right side elevation view of the beverage maker apparatus 100. The beverage maker apparatus 100 for storing refrigerated ingredients and making a beverage comprises a refrigerated storage compartment 101, a control unit 102, and a container 103. The refrigerated storage compartment 101 stores the ingredients. The refrigerated storage compartment 101 comprises pods 101a for storing the ingredients separately. In an embodiment, the pods 101a are of a rectangular configuration. In an embodiment, the pods 101a refrigerate the ingredients at a temperature set by the user. The user can modify the temperature using the control unit 102. The ingredients are, for example, fruits, vegetables, coffee beans, chia seeds, nutella pods, etc. The beverage is, for example, a smoothie, a health drink, protein milkshake, cold coffee, etc. The pods 101a will keep the fruits or vegetables fresh longer than conventional methods. Moreover, the pods 101a are removable and can be placed in a separate freezer if required. The control unit 102 displays options to the user. In an embodiment, the options include, for example, selection of ingredients, refrigeration temperature, quantity of ingredients, quantity of multiple ingredients, etc.

The control unit 102 receives a selection of an option from the user. The control unit 102 maintains the pods 101a at the set temperature via feedback from sensors. The sensors are, for example, temperature sensors, etc., for measuring the temperature of the pods 101a. The control unit 102 actuates one or more of the pods 101a to release one or more of the ingredients based on the selection of the user. The sensor detects the selected frozen pod 101a and dispenses the ingredients based on the selection of the user. The sensors include, for example, temperature sensors, load sensors, etc., for measuring the quantity of the ingredients dispensed and its temperature. The container 103 is positioned on a tray of the beverage maker apparatus 100 for receiving the ingredients from the pods 101a. The container 103 comprises rotary blades 103a for processing the ingredients to make the beverage. In an embodiment, a motor powers the rotary blades 103a. In an embodiment, the container 103 is made of a disposable and biodegradable material. The container 103 is, for example, a 16 oz. cup, water bottle, pitcher, etc.

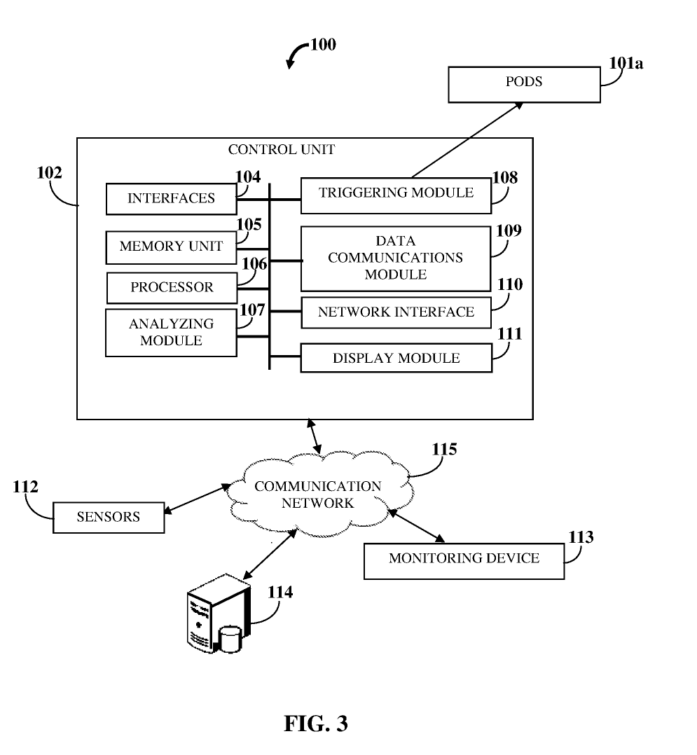

In an embodiment, the beverage maker apparatus 100 is a smoothie machine that makes smoothies from an app, on the machine itself, and via a timer that can start the smoothie making process at any designated time. The refrigerated storage compartment 101 refrigerates the pods 101a, which reduces both time and the need to set up. Furthermore, an alarm can be set to notify the user that the beverage is ready before the user gets up in the morning. Popular beverage recipes along with their calorie measurements are made available to the consumer via the app installed on a monitoring device 113 exemplarily illustrated in FIG. 3. Small increments of measurement ensures maximum customizability. Consumers can also select from among a few preset recipes installed on the beverage maker apparatus 100. The invention reduces the time and the money needed to invest in and to maintain a healthy lifestyle. The app installed on the monitoring device 113 creates structure and an environment designed to support any lifestyle and individual needs ranging from senior citizens, athletes, vegans, etc. In an embodiment, work out videos will be accessible via the server 114 and can be downloaded onto the monitoring device 113, for example, a smartphone, tablet, or laptop.

FIG. 3 exemplarily illustrates a schematic diagram of a beverage maker apparatus 100. In an embodiment, the control unit 102 comprises one or more interfaces 104, a memory unit 105, at least one processor 106, an analyzing module 107, a triggering module 108, a data communications module 109, a network interface 110, and a display module 111. The memory unit 105 is configured to store the sensor data variables generated by the sensors 112. The processor 106 is communicatively coupled to the memory unit 105. The processor 106 is configured to execute computer program instructions defined by modules of the control unit 102. The data communications module 109 is configured to receive the generated sensor data variables from the sensors 112. The display module 111 is configured to display the options on a graphical user interface of the control unit 102. In an embodiment, the graphical user interface is, for example, a touchscreen display, an LED screen, etc. The analyzing module 107 is configured to dynamically analyze the received selection of the option from the user to determine a quantity and a type of the ingredients to be released. The triggering module 108 is configured to actuate the pods 101a to release the refrigerated ingredients based on the received selection of the user.

The data communications module 109 is further configured to receive activation signals from a monitoring device 113. The data communication module 109 transmits the sensor data variables to the monitoring device 113 and a server 114 via a communication network 115 for maintaining the pods 101a at the set temperature. The multiple interfaces 104 connect the sensors 112 to the control unit 102 of the beverage maker apparatus 100. The multiple interfaces 104 are, for example, one or more bus interfaces, a wireless interface, etc. The network interface 120 connects the control module 102 to the communication network 115. As used herein, “bus interface” refers to a communication system that transfers data between components inside a computing device and between computing devices. As used herein, the “monitoring device” is an electronic device, for example, a personal computer, a tablet computing device, a mobile computer, a mobile phone, a smart phone, a portable computing device, a laptop, a personal digital assistant, a smart watch, a wearable device such as the Google Glass™ of Google Inc., the Apple Watch® of Apple Inc., etc., a touch centric device, a workstation, a server, a client device, a portable electronic device, a network enabled computing device, an interactive network enabled communication device, a gaming device, a set top box, a television, an image capture device, a web browser, a portable media player, a disc player such as a Blu-ray Disc® player of the Blu-ray Disc Association, a video recorder, an audio recorder, a global positioning system (GPS) device, a theater system, any entertainment system, any other suitable computing equipment, combinations of multiple pieces of computing equipment, etc.

In an embodiment, the electronic device is a hybrid device that combines the functionality of multiple devices. Examples of a hybrid electronic device comprise a cellular telephone that includes media player functionality, a gaming device that includes a wireless communications capability, a cellular telephone that includes game and electronic mail (email) functions, and a portable device that receives email, supports mobile telephone calls, has music player functionality, and supports web browsing. In an embodiment, computing equipment is used to implement applications such as media playback applications, for example, iTunes® from Apple Inc., a web browser, a mapping application, an electronic mail (email) application, a calendar application, etc. In another embodiment, computing equipment, for example, one or more servers are associated with one or more online services.

In another embodiment, the sensors 112 and the monitoring device 113 are connected to the control unit 102 via the communication network 115. The communication network 115 is a network, for example, the internet, an intranet, a wired network, a wireless network, a communication network that implements Bluetooth® of Bluetooth Sig, Inc., a network that implements Wi-Fi® of Wi-Fi Alliance Corporation, an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, a public telephone network, etc., a local area network, a wide area network, an internet connection network, an infrared communication network, etc., or a network formed from any combination of these networks.

In an embodiment, the sensors 112 are, for example, load sensors, pressure sensors, temperature sensors, etc. The sensors 112 detect temperature of the pods, quantity of the ingredients, etc. The sensors 112 generate multiple sensor data variables based on the detected parameters. The memory unit 105 stores the generated sensor data variables. The processor 106 is communicatively coupled to the memory unit 105. The processor 106 is configured to execute the computer program instructions defined by the modules of the control unit 102 of the beverage maker apparatus 100. The processor 106 refers to any one or more microprocessors, central processor (CPU) devices, finite state machines, computers, microcontrollers, digital signal processors, logic, a logic device, an user circuit, an application specific integrated circuit (ASIC), a field-programmable gate array (FPGA), a chip, etc., or any combination thereof, capable of executing computer programs or a series of commands, instructions, or state transitions. In an embodiment, the processor 106 is implemented as a processor set comprising, for example, a programmed microprocessor and a math or graphics co-processor. The processor 106 is selected, for example, from the Intel® processors such as the Itanium® microprocessor or the Pentium® processors, Advanced Micro Devices (AMD®) processors such as the Athlon® processor, UltraSPARC® processors, microSPARC® processors, HP® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc.

The beverage maker apparatus 100 disclosed herein is not limited to employing a processor 106. In an embodiment, the beverage maker apparatus 100 employs a controller or a microcontroller. The processor 106 executes the modules, for example, 107, 108, 109, 111, etc., of the beverage maker apparatus 100. The analyzing module 107 analyzes the generated sensor data variables to recognize a state of the vehicle based on existing sensor data variables stored in the memory unit 105. In an embodiment, the data communications module 109 is configured to transmit the generated sensor data variables to a server 114 via the communication network 115. This enables remote access to data regarding the temperature of the pods 101a, the quantity of ingredients used, etc. A user may set predefined criteria for the control module 102 to trigger an alarm on the monitoring device 113. In an embodiment, the graphical user interface of the monitoring device 113 provides preset options to notify the user if a beverage is made or if the temperature of the pods 101a are above or below the set temperature. The notification is triggered based on crossing any one, some, or all of threshold data, for example, set minimum temperature of the pods 101a, etc.

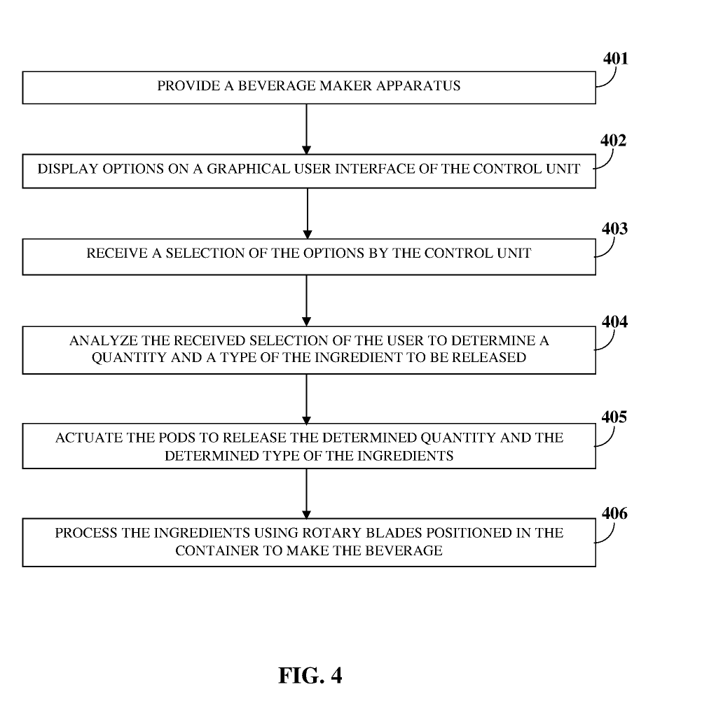

FIG. 4 exemplarily illustrates a method for storing refrigerated ingredients and making a beverage. In the method, disclosed herein, a beverage maker apparatus 100 comprising a refrigerated storage compartment 101, a control unit 102, and a container 103, is provided 401. Multiple options are displayed 402 on a graphical user interface of the control unit 102. A selection of the options is received 403 from the user by the control unit 102. The received selection of the user is analyzed 404 to determine a quantity and a type of the ingredients to be released. The refrigerated pods 101a are actuated 405 to release the determined quantity and the determined type of the ingredients. The ingredients, for example, fruits, vegetables, coffee beans, chia seeds, etc., are processed 406 using rotary blades 103a positioned in the container 103 to make the beverage.

The foregoing examples have been provided merely for the purpose of explanation and are in no way to be construed as limiting of the beverage maker apparatus 100, disclosed herein. While the beverage maker apparatus 100 has been described with reference to various embodiments, it is understood that the words, which have been used herein, are words of description and illustration, rather than words of limitation. Further, although the beverage maker apparatus 100, has been described herein with reference to particular means, materials, and embodiments, the beverage maker apparatus 100 is not intended to be limited to the particulars disclosed herein; rather, the beverage maker apparatus 100 extends to all functionally equivalent structures, methods and uses, such as are within the scope of the appended claims. Those skilled in the art, having the benefit of the teachings of this specification, may effect numerous modifications thereto and changes may be made without departing from the scope and spirit of the beverage maker apparatus 100 disclosed herein in their aspects.

What is claimed is:

1. A beverage maker apparatus for storing refrigerated ingredients and making a beverage, the beverage maker apparatus comprising:
a refrigerated storage compartment for storing the ingredients, the refrigerated storage compartment comprising a plurality of pods for storing the ingredients separately, wherein the ingredients are refrigerated at a set temperature;
a control unit for displaying options to a user, the control unit configured to receive a selection of an option from the user, wherein the control unit maintains the pods at the set temperature via feedback from sensors, and wherein the control unit actuates one or more of the pods to release one or more of the ingredients based on the selection of the user; and
a container positioned on a tray of the beverage maker apparatus for receiving the ingredients from the pods, the container comprising rotary blades mounted to the container for processing the ingredients to make the beverage.

2. The beverage maker apparatus of claim 1, wherein the pods are of a rectangular configuration.

3. The beverage maker apparatus of claim 1, wherein the sensors are one of temperature sensors and load sensors.

4. The beverage maker apparatus of claim 1, wherein the control unit comprises:
a non-transitory computer readable storage medium configured to store sensor data variables generated by the sensors; and
at least one processor communicatively coupled to the non-transitory computer readable storage medium, the at least one processor configured to execute computer program instructions defined by modules of the control unit, the modules of the control unit comprising:
a data communication module configured to receive the generated sensor data variables from the sensors;
a display module configured to display the options on a graphical user interface of the control unit;
an analyzing module configured to dynamically analyze the received selection of the option from the user to determine a quantity and a type of the ingredients to be released;
a triggering module configured to actuate the pods to release the refrigerated ingredients based on the received selection of the user; and
the data communication module further configured to receive activation signals from a monitoring device, wherein the data communication module transmits the sensor data variables to one of the monitoring device and a server via a communication network for maintaining the pods at the set temperature.

5. The beverage maker apparatus of claim 4, wherein the graphical user interface is a touchscreen display.

6. The beverage maker apparatus of claim 4, wherein the monitoring device is one of a smart phone, a tablet, and a laptop.

7. The beverage maker apparatus of claim 1, wherein the beverage is one of a smoothie, a health drink, and a recreational drink.

8. The beverage maker apparatus of claim 1, wherein the container is disposable.

9. The beverage maker apparatus of claim 1, wherein the container is of a biodegradable material.

10. A method for storing refrigerated ingredients and making a beverage, the method comprising:
providing a beverage maker apparatus comprising:
a refrigerated storage compartment comprising a plurality of pods;
a control unit; and
a container positioned on a tray of the beverage dispensing apparatus;
displaying a plurality of options on a graphical user interface of the control unit;
receiving a selection of the options by the control unit;
analyzing the received selection of the user to determine a quantity and a type of the ingredients to be released;
actuating the pods to release the determined quantity and the determined type of the ingredients; and
processing the ingredients using rotary blades mounted to the container to make the beverage.

11. The method of claim 10, wherein the beverage is one of a smoothie and a health drink.

12. The method of claim 10, wherein the container is disposable.

13. The method of claim 10, wherein the container is of a biodegradable material.

14. A processor apparatus for processing ingredients, the processor apparatus comprising:
a refrigerated storage compartment for storing the ingredients, the refrigerated storage compartment comprising a plurality of pods for storing the ingredients separately, wherein the ingredients are refrigerated at a set temperature;
a control unit for displaying options to a user, the control unit configured to receive a selection of an option from the user, wherein the control unit maintains the pods at the set temperature via feedback from sensors, and wherein the control unit actuates one or more of the pods to release one or more of the ingredients based on the selection of the user; and
a container positioned on a tray of the mixer for receiving the ingredients from the pods, the container comprising rotary blades mounted to the container for processing the ingredients.

15. The processor apparatus of claim 14 wherein the sensors are one of temperature sensors and load sensors.

16. The processor apparatus of claim 14, wherein the beverage is one of a smoothie, a health drink, and a recreational drink.

17. The processor apparatus of claim 14, wherein the control unit comprises:
a non-transitory computer readable storage medium configured to store sensor data variables generated by the sensors; and
at least one processor communicatively coupled to the non-transitory computer readable storage medium, the at least one processor configured to execute computer program instructions defined by modules of the control unit, the modules of the control unit comprising:
a data communication module configured to receive the generated sensor data variables from the sensors;
a display module configured to display the options on a graphical user interface of the control unit;
an analyzing module configured to dynamically analyze the received selection of the option from the user to determine a quantity and a type of the ingredients to be released;
a triggering module configured to actuate the pods to release the refrigerated ingredients based on the received selection of the user; and
the data communication module further configured to receive activation signals from a monitoring device, wherein the data communication module transmits the sensor data variables to one of the monitoring device and a server via a communication network for maintaining the pods at the set temperature.

18. The processor apparatus of claim 17, wherein the monitoring device is one of a smart phone, a tablet, and a laptop.
